(19) United States
(12) Patent Application Publication
(10) Pub. No.: US 2008/0031734 A1
(43) Pub. Date: Feb. 7, 2008

(54) Main shaft slide sleeve assembly for remote control helicopter

(76) Inventor: Chien-Chao Chen, Taipei county (TW)

Correspondence Address: CHIEN-CHAO CHEN, 20525 Via Talavera, Yorba Linda, CA, 92887, US

(21) Appl. No.: 11/588,434

(22) Filed: Oct. 30, 2006

(30) Foreign Application Priority Data
Nov. 1, 2005 (TW) 094218851

(51) Int. Cl. B64C 27/605

(52) U.S. Cl. 416/114

(57) ABSTRACT

A main shaft slide sleeve assembly for remote control helicopter includes a slide sleeve fixedly connected to a main shaft of the helicopter; a spherical hub disposed in the slide sleeve to connect to a swash plate via two hub links, and to two flybar rods via two projected columns; a main blade central hub horizontally held in the slide sleeve to connect at two ends to two main blade holders; and two washout control levers pivotally turnably connected at respective middle section, outer end, and inner end to the two main blade holders, the flybar rods via two first link, and the swash plate via two second links. Thus, the swash plate may control deflection angles of two flybar paddles on the two flybar rods and two main blades on the main blade holders via the hub links and the second links.

### FIELD OF THE INVENTION

The present invention relates to a main shaft slide sleeve assembly for remote control helicopter, and more particularly to a main shaft slide sleeve assembly for remote control helicopter that is simple in structure and easy to assembly, and ensures stable control of the remote control helicopter.

### BACKGROUND OF THE INVENTION

A conventional propeller with two blades extended in two opposite directions or angularly spaced by 180 degrees tends to vibrate and sway violently while rotating due to a relatively large space between two loads. As a result, it is uneasy to stably control the fly of the remote control helicopter. To solve this problem, two perpendicularly extended flybar rods are provided between the two blades. In a somewhat simple design referred to as the Bell System, the flybar rods are provided at outer ends with a stabilizer each. However, in this design, the vibration and sway of the propeller could not be completely eliminated in practical use of the propeller. In another design referred to as the Hiller System, a flybar paddle is provided at an outer end of each of the two flybar rods to obtain improved stability for the propeller. However, the Hiller System involves in relatively complicate structure and operation, and accordingly increased difficulty in design. Therefore, most currently available remote control helicopters have a Bell-Hiller System to combine the advantages of the Bell System and the Hiller System for the propeller to be more easily controllable and the helicopter to fly more stably.

In a conventional remote control helicopter adopting the Bell-Hiller System, the main shaft slide sleeve assembly thereof is connected to the main blades in a horizontal direction, and is also connected to a flybar rod. In one of many very common structures for the conventional main shaft slide sleeve assembly, a spherical hub is axially slidably disposed in a main shaft slide sleeve. A flybar rod is extended through two diametrically opposite sides of the spherical hub, and is connected at two outer ends to two flybar paddles. A swash plate controllable via a plurality of servos is connected to the flybar rod and two main blade holders via a plurality of links, so as to control the deflection angles of the two flybar paddles and the two main blades, and achieve improved operating and fly stability.

In an early structure, the main shaft slide sleeve assembly includes an inner slide sleeve internally provided with an open cavity, in which the spherical hub is axially slidably disposed. The inner slide sleeve is provided around a peripheral wall thereof with a plurality of symmetrically arranged and axially extended open slots, via which the flybar rod extended through the spherical hub extends two outer ends to outer side of the slide sleeve. Then, the inner slide sleeve is disposed in an outer slide sleeve via an opening thereof, and the outer slide sleeve is sealed to receive the inner slide sleeve therein, so that the spherical hub is indirectly received in the outer slide sleeve. The above-described structure includes a lot of components and is therefore very complicated. Moreover, the components have shapes that could not be easily machined and processed. Therefore, the conventional main shaft slide sleeve assembly for remote control helicopter requires high manufacturing and assembling costs to reduce the product's competing ability in the market.

It is therefore tried by the inventor to develop an improved main shaft slide sleeve assembly for remote control helicopter to overcome the above-mentioned drawbacks.

### SUMMARY OF THE INVENTION

A primary object of the present invention is to provide a main shaft slide sleeve assembly for remote control helicopter that has simplified overall structure and components to enable reduced manufacturing and assembling costs of the remote control helicopter.

Another object of the present invention is to provide a main shaft slide sleeve assembly for remote control helicopter that has simplified overall structure to effectively reduce the probability of functional failure and increase the operating reliability of the remote control helicopter.

To achieve the above and other objects, the main shaft slide sleeve assembly for remote control helicopter according to the present invention mainly includes a slide sleeve, a spherical hub, a main blade central hub, and two washout control levers.

The slide sleeve is formed at a lower portion with a receiving space having a bottom opening, via which a main shaft of a remote control helicopter is extended into and fixed to the slide sleeve. The slide sleeve is further formed on a peripheral wall thereof with a plurality of symmetrically arranged and axially extended long slots as well as a pair of symmetrically and oppositely arranged horizontal through holes.

The spherical hub is provided on an outer surface at two diametrically opposite positions with two flattened areas, so that the spherical hub may be vertically turned and extended into the receiving space of the slide sleeve via any one of the long slots. The spherical hub is further provided on the outer surface between the two flattened areas with two diametrically opposite screw holes for two stop bolts to thread thereinto via two of the long slots on the slide sleeve, and two diametrically opposite and radially outward projected columns perpendicular to the two screw holes in the same plane. The two stop bolts are connected to predetermined points on a swash plate via two hub links. Two flybar rods are connected at inner ends to outer ends of the two projected columns, such that the two flybar rods are extended from the spherical hub through another two of the long slots to outside of the slide sleeve.

The main blade central hub is horizontally extended through and held in the two symmetrically arranged horizontal through holes on the slide sleeve, and is connected at two outer ends to two main blade holders for assembling two main blades thereto. Each of the two main blade holders includes a sidewardly projected arm.

Each of the two washout control levers is pivotally turnably connected near a middle section to an outer end of the sideward projected arm of one main blade holder, at an outer end to one flybar rod via a first link, and at an inner end to a predetermined point on an outer edge of the swash plate via a second link, such that the swash plate may control deflection angles of two flybar paddles on the flybar rods and the two main blades on the main blade holders via the hub links and the second links.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a main shaft slide sleeve assembly for remote control helicopter according to the present invention;

FIG. 2 is an assembled view of FIG. 1; and

FIGS. 3 and 4 are perspective views showing the operation of the present invention.

### DETAILED DESCRIPTION OF THE PREFERRED EMBODIMENTS

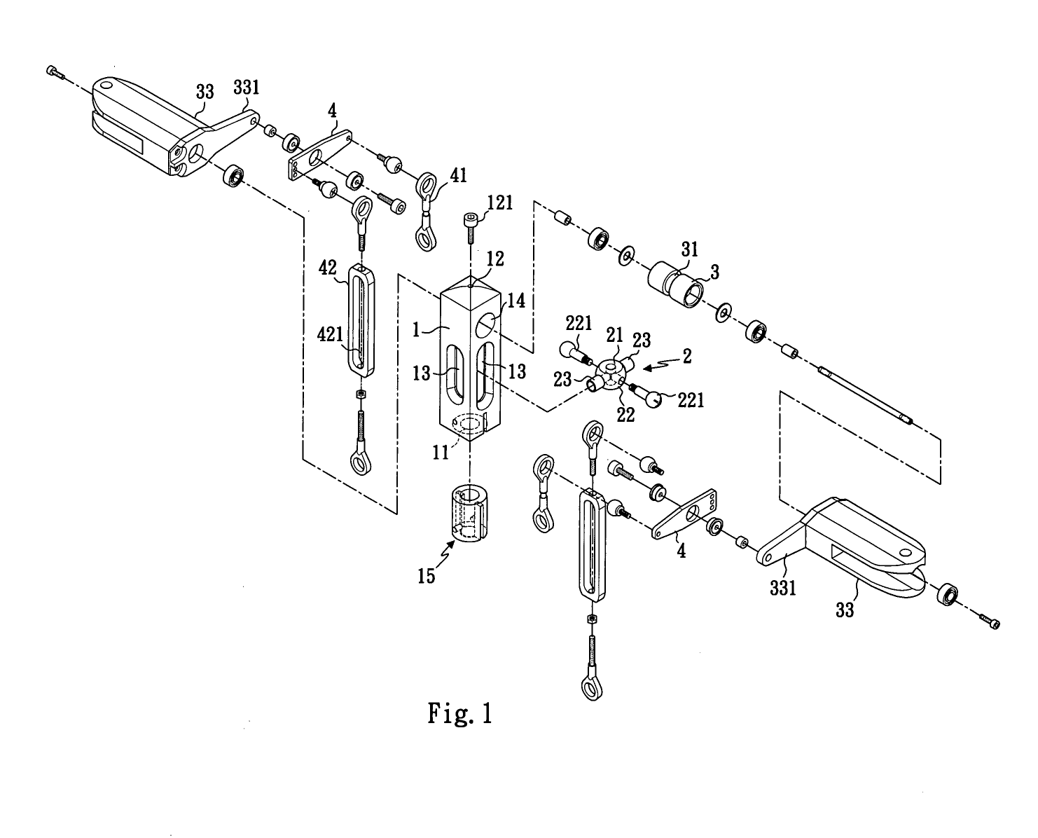

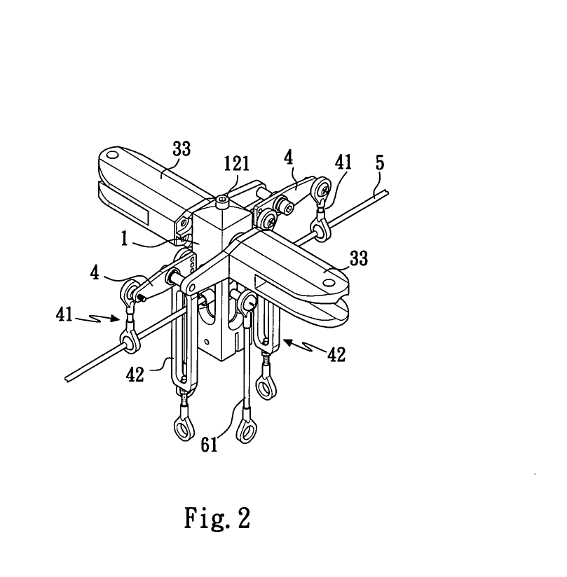

Please refer to FIGS. 1 and 2 that are exploded and assembled perspective views, respectively, of a main shaft slide sleeve assembly for remote control helicopter according to the present invention. As shown, the present invention mainly includes a slide sleeve 1, a spherical hub 2, a main blade central hub 3, and two washout control levers 4.

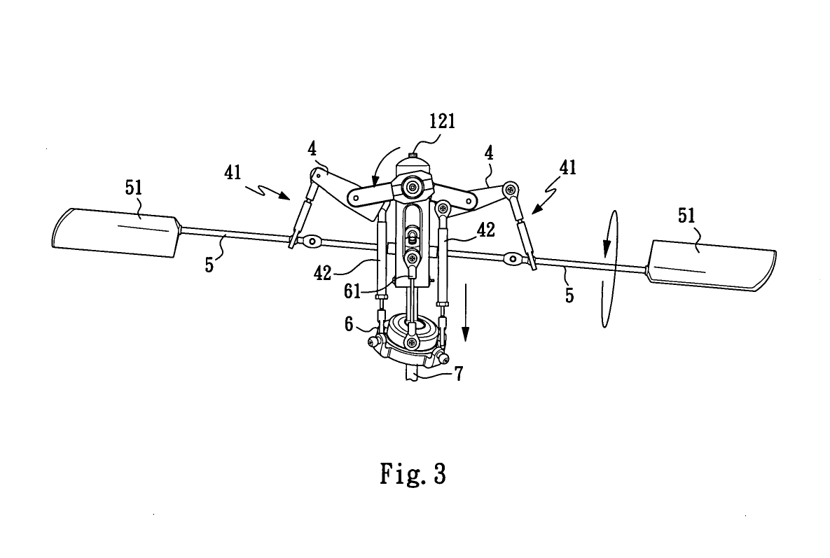

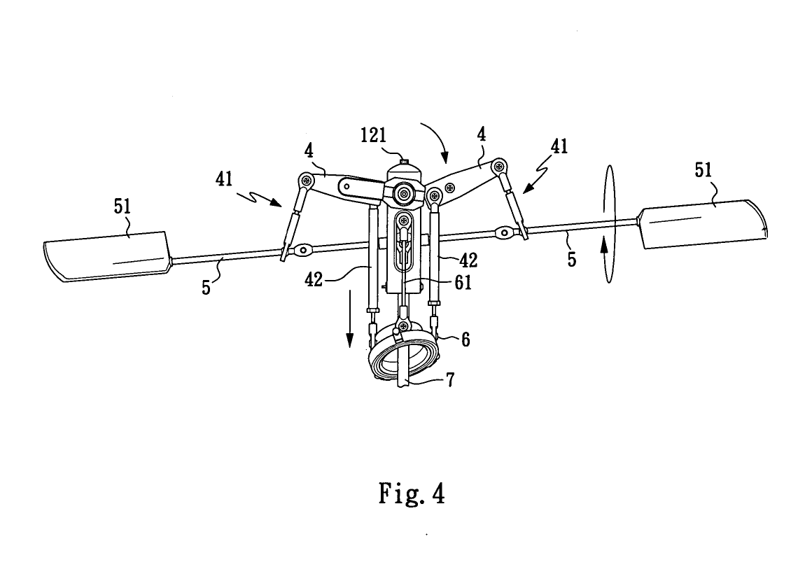

The slide sleeve 1 is formed at a lower portion with a receiving space having a bottom opening 11, via which a main shaft sleeve 15 is mounted into the slide sleeve 1 for connecting a main shaft 7 thereto (see FIGS. 3 and 4). The slide sleeve 1 is also formed at a top with a top screw hole 12, and on a peripheral wall thereof with a plurality of symmetrically arranged and axially extended long slots 13 as well as a pair of symmetrically and oppositely arranged horizontal through holes 14.

The spherical hub 2 is provided on an outer surface at two diametrically opposite positions with two flattened areas 21, so that the spherical hub 2 may be vertically turned and extended into the receiving space of the slide sleeve 1 via any one of the long slots 13. The spherical hub 2 is further provided on the outer surface between the two flattened areas 21 with two diametrically opposite screw holes 22 and two diametrically opposite and radially outward projected columns 23 perpendicular to the two screw holes 22 in the same plane. Two stop bolts 221 are threaded through two diametrically opposite long slots 13 into the two screw holes 22. A swash plate 6 is connected to the spherical hub 2 via two hub links 61, each of which is connected at an end to one stop bolt 221 and at the other end to a predetermined point on the swash plate 6. Two flybar rods 5 are connected at inner ends to outer ends of the two projected columns 23, and extended to an outer side of the slide sleeve 1 via another two diametrically opposite long slots 13, and two flybar paddles 51 are connected to outer ends of the two flybar rods 5 located outside the slide sleeve 1.

The main blade central hub 3 is horizontally extended through the two symmetrically arranged horizontal through holes 14 to locate in the slide sleeve 1, and is provided at a middle section with an annular groove 31. A locking bolt 121 is threaded through the top screw hole 12 into the annular groove 31 to thereby hold the main blade central hub 3 in the slide sleeve 1. Two main blade holders 33 are connected at respective inner end to two outer ends of the main blade central hub 3, so that two main blades (not shown) may be connected to the main blade center hub 3 via the two main blade holders 33. Each of the main blade holders 33 includes a sidewardly projected arm 331.

Each of the two washout control levers 4 is pivotally turnably connected near a middle section to an outer end of the sideward projected arm 331 of one corresponding main blade holder 33, at an outer end to one corresponding flybar rod 5 via a first link 41, and at an inner end to a predetermined point on an outer edge of the swash plate 6 via a second link 42. The second links 42 are provided at respective middle section with an open slot 421, allowing the flybar rods 5 to extend therethrough and to shift or angularly deflect therein.

FIGS. 3 and 4 show the operation of the main shaft slide sleeve assembly for remote control helicopter according to the present invention. As shown, the main shaft 7 is upward extended through a center of the swash plate 6 to connect to the bottom of the slide sleeve 1, via which the main shaft 7 may drive the main blades or propellers to rotate. The swash plate 6 is controlled by a plurality of servos (not shown) to tilt indifferent directions and at different angles, so as to control deflection angles of the two flybar paddles 51 on the flybar rods 5 and the two main blades on the main blade holders 33 via the hub link 61 and the second links 42, so that the remote control helicopter may be controlled to fly in different movements.

In brief, the main shaft slide sleeve assembly for remote control helicopter according to the present invention has simple structure and is easy to assemble to enable stable control of a remote control helicopter.

What is claimed is:

1. A main shaft slide sleeve assembly for remote control helicopter, comprising a slide sleeve, a spherical hub, a main blade central hub, and two washout control levers;
said slide sleeve being formed at a lower portion with a receiving space having a bottom opening, via which a main shaft of a remote control helicopter is extended into and fixed to said slide sleeve; and said slide sleeve being further formed on a peripheral wall thereof with a plurality of symmetrically arranged and axially extended long slots as well as a pair of symmetrically and oppositely arranged horizontal through holes;
said spherical hub being provided on an outer surface at two diametrically opposite positions with two flattened areas, so that said spherical hub may be vertically turned and extended into said receiving space of said slide sleeve via any one of said long slots; said spherical hub being further provided on the outer surface between said two flattened areas with two diametrically opposite screw holes for two stop bolts to thread thereinto via two of said long slots on said slide sleeve, and two diametrically opposite and radially outward projected columns perpendicular to said two screw holes at the same plane; said two stop bolts being connected to predetermined points on a swash plate via two hub links; and two flybar rods being connected at inner ends to outer ends of said two projected columns, such that said two flybar rods are extended from said spherical hub through another two of said long slots to outside of said slide sleeve;
said main blade central hub being horizontally extended into and held in said two symmetrically arranged horizontal through holes on said slide sleeve, said main blade central hub being connected at two outer ends to two main blade holders for assembling two main blades thereto; and each of said main blade holders including a sidewardly projected arm; and
each of said two washout control levers being pivotally turnably connected near a middle section to an outer end of said sideward projected arm of one said main blade holder, at an outer end to one said flybar rod via a first link, and at an inner end to a predetermined point on an outer edge of said swash plate via a second link, such that said swash plate may control deflection angles of two flybar paddles on said flybar rods and said two main blades on said main blade holders via said hub links and said second links.

2. The main shaft slide sleeve assembly for remote control helicopter as claimed in claim 1, wherein said main blade central hub is provided at a middle section with an annular groove, and said slide sleeve is provided at a top with an axially extended top screw hole communicating with said horizontal through holes, such that a locking bolt may be threaded through said axial top screw hole into said annular groove on said main blade central hub to thereby hold said main blade central hub in said slide sleeve.

3. The main shaft slide sleeve assembly for remote control helicopter as claimed in claim 2, further comprising a main shaft sleeve disposed between said bottom opening on said slide sleeve and said main shaft of said remote control helicopter.

4. The main shaft slide sleeve assembly for remote control helicopter as claimed in claim 3, wherein both of said second links are provided at a middle section with an open slot to allow said flybar rods to extend therethrough and to shift or angularly deflect therein.
